(19) United States
(12) Patent Application Publication
(10) Pub. No.: US 2016/0183478 A1
(43) Pub. Date: Jun. 30, 2016

(54) Drainage Element

(71) Applicant: Thomas Vaeth, Hessen (DE)

(72) Inventor: Thomas Vaeth, Hessen (DE)

(21) Appl. No.: 14/965,596

(22) Filed: Dec. 10, 2015

Related U.S. Application Data
(63) Continuation of application No. 12/440,583, filed on Jan. 5, 2010, now abandoned.

(30) Foreign Application Priority Data
Sep. 16, 2006 (DE) 10 2006 043 571.0

(51) Int. Cl. A01G 9/24; B01D 39/14; B01D 35/027

(52) U.S. Cl. CPC A01G 9/247; B01D 35/0273; B01D 39/14

(57) ABSTRACT

The present invention is a drainage element for a plant container including in a preferred embodiment a first element having randomly oriented interlacing component or tangled braid and a second element including a filter mat which encases the randomly oriented interlacing. In another preferred embodiment, the filter mat element overlies the randomly oriented interlacing when in use, for example to cover the bottom of a plant container.

### CROSS-REFERENCE TO RELATED APPLICATION(S)

This application is a continuation of U.S. application Ser. No. 12/440,583, filed Jan. 5, 2010 and entitled “Drainage Element, which was a §371 national stage application of PCT Application No. DE2007/001573, filed on Sep. 1, 2007 and entitled “Entwässerungselement,” which was an International Application claiming priority to German Patent Application No. 10 2006 043 571.0, which was filed on Sep. 16, 2006, all of which are hereby incorporated herein by reference in their entirety.

### BACKGROUND OF THE INVENTION

The invention relates to a drainage element for a plant container.

### SUMMARY OF THE INVENTION

Known from EP 1 702 506 A1 is a drainage element, therein called Drainage Set for plant containers, which presents a cohesive covering made of geotextile tissue. Contained within is a drainage material in the form of grains. Due to gravity such a grain is squeezable into a drainage hold of a plant container and the drainage hold thus sealable. The enclosing geotextile tissue serves as a seal in this environment. Drainage is not provided for.

Known from DE 203 12 056 is a drainage element, therein called drainage element, which consists of a covering with a hole to enable fluids to pass through and a drainage mass, wherein the drainage mass is encased by the covering and consists of at least two different water-storing and respectively water-conducting components.

Collectively termed geotextiles are functional textiles used in civil and underground engineering to separate, filter and drain. One of these geotextiles is an endless mat, also known as a geogrid, which presents a randomly oriented interlacing or tangled braid in between two filter materials.

The endless mats are open on the side margins and the specific strata are recognizable. At least one of the filter mats overlaps in such a way that the filter mats of adjoined geotextile mats prevent openings overlapping each other and thus the leakage of sand and such like is averted.

The invention therefore underlies the task of providing for an easier and improved drainage element.

This task is achieved through the criteria of the coordinate main claims. In accordance with the invention, the dewatering or drainage element presents a randomly oriented interlacing or tangled braid and a filter mat which encases the randomly oriented interlacing or tangled braid or the drainage element presents a randomly oriented interlacing or tangled braid and a filter mat, wherein the filter mat overlaps in such a way that in the operating state the randomly oriented interlacing or tangled braid is covered by the filter mat. In various implementations according to the invention, the dewatering or drainage element is a non-woven fiber braid and the random braid encasing filter mat or the drainage element is a non-woven fiber mesh, and a filter pad, and the filter mat is so on the random mesh, that in the operating state, the non-woven fiber mesh is covered by the filter mat. The randomly oriented interlacing or tangled braid is of such stiffness that it is capable of keeping its original height even under the pressure of incumbent flower soil and thus will not be compressed under such circumstances. The drainage element is manufactured with a low height or thickness and provides for optimal drainage. Accordingly, siltation and rot in a plant container is precluded. Plant containers are subsequently also referred to as flower containers or flower pots and the drainage element is also referred to as drainage cushion, drainage pad or, in short, a drainpad. The filter mat serves as filter layer and is thus referred to as filter layer. The drainage element prevents flower soil and substrate from flushing out, so that a loss of substrate and flower soil as well as pollution around the plant container is averted. The substrate serves as a breeding ground. The drainage element is extremely light in weight, easy to clean and reusable.

At least one end area of the filter mat is sewn together. A first embodiment presents a one-piece filter mat. One end area is sewn so that the filter mat encases the randomly oriented interlacing or tangled braid. In a second embodiment, the drainage element presents a two-piece filter mat and the end areas are sewn together. The drainage element is designed as a pad and thus easy to produce.

At least one end area of the filter is welded together. A first embodiment presents a one-piece filter mat. One end area is welded so that the filter mat encases the randomly oriented interlacing or tangled braid. In a second embodiment, the drainage element presents a two-piece filter mat and the end areas are welded together. The drainage element is designed as a pad and thus easy to produce.

At least one end area of the filter mat is glued together. A first embodiment presents a one-piece filter mat. One end area is glued so that the filter mat encases the randomly oriented interlacing or tangled braid. In a second embodiment, the drainage element presents a two-piece filter mat and the end areas are glued together. The drainage element is designed as a pad and thus easy to produce.

For a better understanding of the invention, the embodiments are subsequently elucidated in more detail on the basis of the drawings.

### BRIEF DESCRIPTION OF THE FIGURES

FIG. 1A a plan view of a disc-shaped drainage element with a randomly oriented interlacing or tangled braid and two-piece filter mat covering the randomly oriented interlacing or tangled braid.

FIG. 1B is a cross-sectional view of the drainage element of FIG. 1A with the randomly oriented interlacing or tangled braid encased by the filter mat.

FIG. 2A a plan view of a rectangular-shaped drainage element with a randomly oriented interlacing or tangled braid and a one-piece filter mat covering the randomly oriented interlacing or tangled braid.

FIG. 2B is a cross-sectional view of the drainage element of FIG. 1B with the randomly oriented interlacing or tangled braid encased by the filter mat.

FIG. 3A a plan view of an alternative embodiment of a rectangular-shaped drainage element with a randomly oriented interlacing or tangled braid and a filter mat attached to one side of the randomly oriented interlacing or tangled braid.

FIG. 3B is a side elevational view of the drainage element of FIG. 3A with a randomly oriented interlacing or tangled braid and a filter mat attached to one side of the randomly oriented interlacing or tangled braid from side view.

FIG. 4 is a cross-sectional view of the drainage element of FIGS. 1A and 1B shown in place in a conical flower container.

FIG. 5 is a cross-sectional view of the drainage element of FIGS. 3A and 3B shown in place in a rectangular flower container.

### DESCRIPTION OF THE INVENTION

Elements that are similar or the same are marked with identical reference signs throughout the various figures.

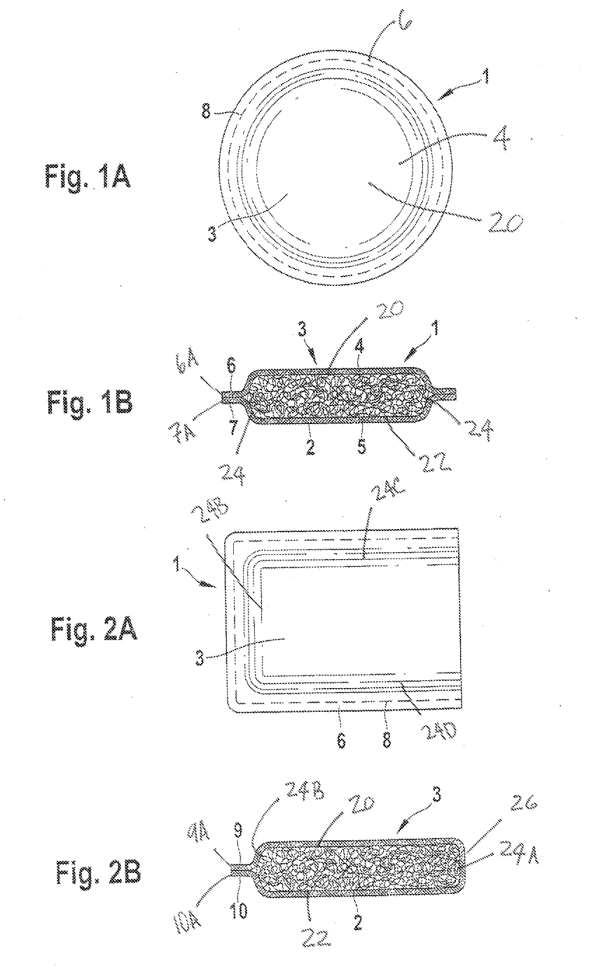

FIGS. 1A and 1B depict a disc-shaped drainage element 1 with a randomly oriented interlacing or tangled braid 2, encased by a two-piece filter mat 3. The randomly oriented interlacing or tangled braid 2 is also disc-shaped and presents a first frontal area 20, a second frontal area 22, and at least one peripheral surface 24. The filter mat 3 consists of two parts carried out with a first filter mat piece 4 and a second filter mat piece 5. The first filter mat piece 4 covers the first frontal area 20 and shows a first filter mat end area 6 that protrudes beyond the first frontal area 20. The second filter mat piece 5 covers the second frontal area 22 and shows a second filter mat end area 7 that protrudes beyond the second frontal area 22. The outer end of the filter mat 3 comprises a first end area 6 and second end area 7 which overlap on the peripheral surface 24 and are sewn together with thread 8. These respective end areas 6, 7 can alternatively be glued or welded together as well, such that the first end area 6 and second end area 7 are oriented in the same direction (as shown at 6A and 7A, respectively).

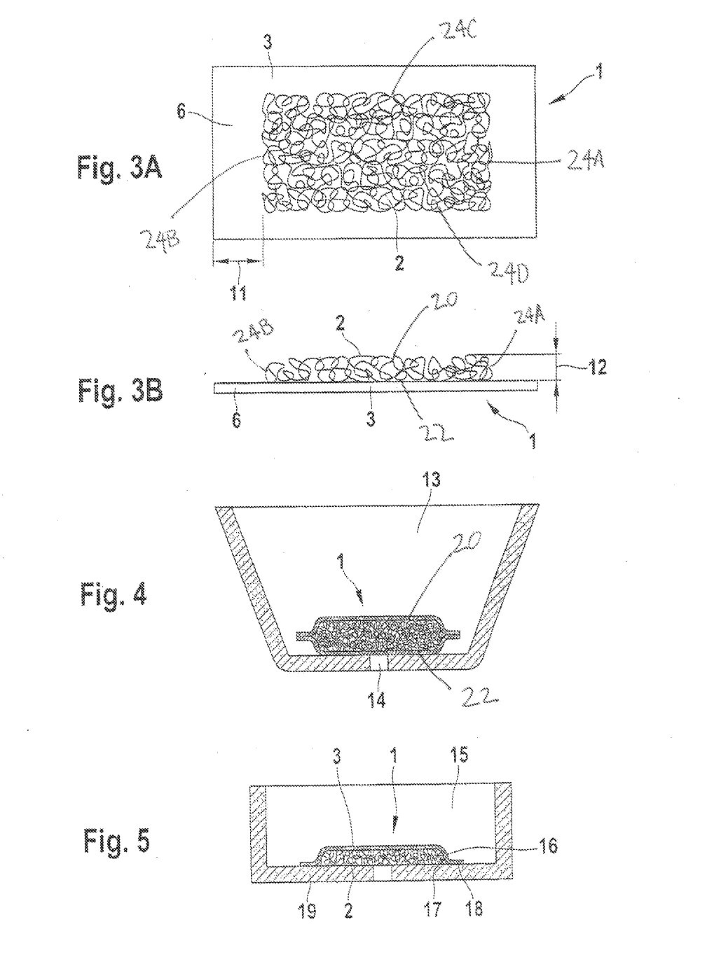

FIGS. 2A and 2B depict an embodiment of the drainage element 1 with a rectangular-shaped randomly oriented interlacing or tangled braid 2, encased by a one-piece filter mat 3. The randomly oriented interlacing or tangled braid 2 presents an upper surface and an opposing bottom surface and four peripheral sides 24A, 24B, 24C, 24D with smaller surfaces (as is also shown in FIG. 3A). The filter mat 3 is put around the randomly oriented interlacing or tangled braid 2 in such a way so as to enclose the interlacing or tangled braid 2. The filter mat 3 presents an outer end area that protrudes above three peripheral sides 24B, 24C, 24D and is sewn. The filter mat 3 also has an surface 26 that is directly adjacent to the remaining peripheral side 24A. Components 9 and 10 of the end area 6 come to lie on top of each other at three peripheral sides and are there sewn together. These respective end areas 9, 10 can alternatively be glued or welded together as well, such that the first end area 9 and second end area 10 are oriented in the same direction (as shown at 9A and 10A, respectively).

FIGS. 3A and 3B depict a second rectangular drainage element 1 with a rectangular randomly oriented interlacing or tangled braid 2 and a filter mat 3. The filter mat 3 covers one side of the randomly oriented interlacing or tangled braid 2 and presents an overlapping end area that protrudes above the randomly oriented interlacing or tangled braid 2. The randomly oriented interlacing or tangled braid 2 presents an upper surface and an opposing bottom surface and four peripheral sides 24A, 24B, 24C, 24D with smaller surfaces. As shown in FIG. 3A, one length 11 of the end area 6 is chosen in such a magnitude that a value of this length is greater than a value of a height 12 of the randomly oriented interlacing or tangled braid 2 (shown in FIG. 3B).

FIG. 4 depicts the disc-shaped drainage element 1 arranged in a round plant container 13. A flower pot outlet 14 of the flower pot 13 is covered by using the drainage element 1. So if the flowerpot 13 is filled up with flower soil, substrate and a plant, the drainage element 1 will retain or keep its original height and when watering the flower pot 13 the water will be able to drain off the drainage element 1 and out the flower pot outlet 14.

FIG. 5 depicts the second rectangular drainage element 1 arranged in an oblong square flower pot 15. The filter mat 3 is chosen in such a magnitude that it fits a side rim 17 of the randomly orientated interlacing at a first area 16 and comes to rest on a base 19 of the flower pot at a second area 18 in the operating state.

The invention relates to a drainage element 1 for a plant container 13. In accordance with the invention, the drainage element 1 presents a randomly oriented interlacing or tangled braid 2 and a filter mat 3 which surrounds the randomly oriented interlacing or tangled braid 2 or the drainage element 1 presents a randomly oriented interlacing or tangled braid 2 and a filter mat 3 and the filter mat 3 projects beyond the randomly orientated interlacing or tangled braid 2 in such a way that the randomly orientated interlacing or tangled braid 2 is covered by the filter mat 3 in the operating state.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A drainage device for a plant container, comprising:
a. a drainage element comprising a randomly oriented tangled braid comprising:
i. a first frontal area;
ii. a second frontal area; and
iii. at least one peripheral area; and
b. a filter mat comprising a first filter mat piece comprising at least a first end area, the filter mat being configured to encase the drainage element,
wherein the drainage device is configured to be placed in a plant container to remove water from the plant container.

2. The drainage device of claim 1, wherein the drainage element is compression- resistant.

3. The drainage device of claim 1, wherein the first frontal area and second frontal area are substantially rectangular.

4. The drainage device of claim 1, wherein the filter mat further comprises a second filter mat piece comprising a second end area, and further wherein:
a. the first filter mat piece and second filter mat are configured to cover the first frontal area and second frontal area, respectively, and
b. the first end area and second end area are configured to extend beyond the first frontal area and second frontal area, respectively, so as to be attached.

5. The drainage device of claim 4, wherein the drainage element is disc-shaped.

6. The drainage device of claim 4, wherein the drainage element is configured to be in fluidic communication with flower soil so as to remove water.

7. A disc-shaped drainage device for a plant container, comprising:
a. a disc-shaped drainage element comprising a randomly oriented tangled braid comprising:
i. a first frontal area;
ii. a second frontal area; and
iii. at least one peripheral area,
wherein the first frontal area and second frontal area define a disc shape of a first diameter; and
b. a disc-shaped filter mat comprising:
i. a first filter mat piece comprising at least one end area; and
ii. a second filter mat piece comprising a second end area, wherein:
A. the first filter mat piece and second filter mat piece define a disc shape of a second diameter, and
B. the disc-shaped filter mat is configured to encase the disc-shaped drainage element.

8. The drainage device of claim 7, wherein:
a. the first filter mat piece and second filter mat piece are configured to cover the first frontal area and second frontal area, respectively, and
b. the first end area and second end area are configured to extend beyond the first frontal area and second frontal area, respectively, so as to be attached.

9. The drainage device of claim 8, wherein the drainage device is configured to be placed in a plant container to remove water from the plant container.

10. The drainage device of claim 8, wherein the first end area and second end area are sewn together.

11. The drainage device of claim 8, wherein the first end area and second end area are glued together.

12. A rectangular-shaped drainage device for a plant container, comprising:
a. a rectangular-shaped drainage element comprising a randomly oriented tangled braid comprising:
i. a first frontal area;
ii. a second frontal area and; and
iii. a first peripheral area;
iv. a second peripheral area;
v. a third peripheral area; and
vi. a fourth peripheral area,
wherein the first, second, third and fourth peripheral areas define a rectangle; and
b. a rectangular filter mat comprising a first filter mat piece comprising at least one end area configured to enclose at least the first frontal area.

13. The drainage device of claim 12, wherein the first filter mat piece further comprises a second end area.

14. The drainage device of claim 13, wherein the first filter mat piece is further configured to enclose the second frontal area.

15. The drainage device of claim 14, the first end area and second end area are configured to be fixedly attached adjacent to a peripheral area selected from the group consisting of: the first peripheral area, the second peripheral area, the third peripheral area and the fourth peripheral area.

16. The drainage device of claim 15, wherein the first end area and second end area are sewn together.

17. The drainage device of claim 15, wherein the first end area and second end area are glued together.

18. The drainage device of claim 15, wherein the filter mat further comprises a surface that is directly adjacent to one peripheral side.
